(19) United States
(12) Patent Application Publication
(10) Pub. No.: US 2016/0216957 A1
(43) Pub. Date: Jul. 28, 2016

(54) SYSTEM AND METHOD FOR REMOTELY UPDATING FIRMWARE FOR INDIVIDUAL LIGHTING CONTROLLERS IN AVIATION LIGHT SYSTEM

(71) Applicant: LSIS CO., LTD., Gyeonggi-do (KR)

(72) Inventor: Jae-Shik Yoon, Gyeonggi-do (KR)

(21) Appl. No.: 15/003,645

(22) Filed: Jan. 21, 2016

(30) Foreign Application Priority Data
Jan. 22, 2015 (KR) 10-2015-0010371

(51) Int. Cl. G06F 9/445

(52) U.S. Cl. CPC G06F 8/65

(57) ABSTRACT

A system for remotely updating firmware of individual lighting controllers in an aviation light system according to an embodiment of the present invention includes at least one individual lighting controller for, when a firmware is updated, changing an application mode of controlling a lamp to a boot mode of performing the update and directly storing the firmware on a program memory equipped therein, and a relay for receiving the firmware and update related data from an external device to transfer them to the individual lighting controller.

### CROSS REFERENCE TO RELATED APPLICATION

This application claims the benefit of Korean Patent Application No. 10-2015-0010371 filed on Jan. 22, 2015, the disclosure of which is incorporated by reference in its entirety.

### BACKGROUND

1. Technical Field

The present disclosure relates to a system and method for remotely updating firmware of individual lighting controllers in an aviation light system.

2. Description of the Related Art

An aviation light refers to a facility established in line with the Ordinance of Ministry of Transportation as an aviation safety facility for aiding an aircraft navigation by means of lights under Aviation Act. An aircraft pilot carries out most of aircraft operations depending on a sight and a hearing. Since he/she monitors most of information through eyes, aviation lights play highly important roles.

An Individual Lamp Control and Monitoring System (ILCMS) is a system for controlling a turn on/off of the aviation lights placed in a runway and a taxiway, and for monitoring states of the aviation lights. A power supply for the aviation lights is a constant current source having a single loop. A power line from a constant current regulator generating a constant current to an end terminal lamp placed along the runway is coupled with tens to hundreds lamps and a length of the power line ranges a few to tens kilometers. The power supply for the aviation lights forming the single loop may supply a power to an electronic circuit for operating secondary lamps and ILCMS through buried transformers, each of which has a current transformer characteristic. In an airport, since a communication between the aircraft pilot and a control tower is done by wireless, a wire communication is preferred in order to suppress interferences caused by other wireless communications. In a conventional airport, it is difficult to newly install communication lines, and hence it is essential to apply a power line communication to the ILCMS.

An individual lighting controller for the power line communication required to control the aviation lights in ILCMS is installed at the runway exposed to an external environment. Therefore, it is required to necessarily comply with IP68 for protecting the individual lighting controller for the power line communication from the external environment.

Even now, mandates applied to the aviation light system have been being modified and new aviation lights have been being developed. As a result, a situation where a firmware for the individual lighting controller should be updated may occur according to requirements of the airport. However, the individual lighting controller is formed or installed in a configuration where it is completely molded to safely protect the individual lighting controller from the external environment, and thus firmware for the individual lighting controller should be able to be remotely updated.

### SUMMARY

It is an aspect of some embodiments of the present disclosure to provide a system for remotely updating firmware of the individual lighting controllers in an aviation light system, in which a firmware is directly stored and updated on a program memory equipped in an individual lighting controller without a separate memory for storing thereon firmware remotely provided.

To address the foregoing problem, a system for remotely updating firmware of individual lighting controllers in an aviation light system according to an embodiment of the present invention includes at least one individual lighting controller for, when a firmware is updated, changing an application mode for controlling a lamp to a boot mode for performing the update and directly storing the firmware on a program memory equipped therein, and a relay for receiving the firmware and update related data from an external device to transfer them to the individual lighting controller.

In an embodiment, the update related data may include a UID (unique identification) separately specifying the individual lighting controller, and the update may be performed for the at least one individual lighting controller based on the UID.

In an embodiment, the individual lighting controller may enter the boot mode pursuant to an instruction to enter the boot mode contained in the update related data.

In an embodiment, the update related data may contain a memory address identifying a storage location in the program memory, and the individual lighting controller may directly store the firmware on the storage location corresponding to the identified memory address.

In an embodiment, the firmware may consist of multiple pieces of firmware data formed by dividing the firmware, and the individual lighting controller may sequentially store the multiple pieces of firmware data on the storage location corresponding to the identified memory address.

In an embodiment, the individual lighting controller may switch an application region to a boot region in the program memory under the boot mode and directly store the firmware on the boot region, the application region may be a region for a control and an operation of the individual lighting controller, and the boot region may be a region for a remote firmware update.

In an embodiment, the individual lighting controller may change the boot mode back to the application mode when the update is completed, thereby switching the boot region back to the application region.

In an embodiment, wherein the at least one individual lighting controller and the relay may be connected through a power line communication, the relay may be a power line communication concentrator, and the at least one individual lighting controller may be a power line communication terminal.

To address the foregoing problem, a firmware-remotely-update method for individual lighting controllers in an aviation light system according to another embodiment of the present invention includes at least one individual lighting controller, when a firmware is updated, being changed from an application mode for controlling a lamp to a boot mode for performing the update, the at least one individual lighting controller receiving the firmware from an external device through a relay, and the at least one individual lighting controller directly storing the received firmware on a program memory equipped therein.

In an embodiment, at least one individual lighting controller being changed from an application mode for controlling a lamp to a boot mode for performing the update may include the individual lighting controller receiving an instruction to enter the boot mode and a UID separately specifying the individual lighting controller from the external device, and the at least one individual lighting controller entering the boot mode based on the instruction and the UID.

In an embodiment, the at least one individual lighting controller receiving the firmware from an external device through a relay may include receiving a memory address identifying a storage location in the program memory, and the at least one individual lighting controller directly storing the received firmware on a program memory equipped therein may include directly storing the firmware on the storage location corresponding to the identified memory address.

In an embodiment, the at least one individual lighting controller directly storing the received firmware on a program memory equipped therein may include changing an application region to a boot region in the program memory and directly storing the received firmware on the boot region, and the application region is a region for a control and an operation of the individual lighting controller and the boot region is a region for a remote firmware update.

In an embodiment, the method further includes changing the boot mode back to the application mode when the update is completed and changing the boot region back to the application region.

In an embodiment, the at least one individual lighting controller and the relay may be connected through a power line communication, the relay may be a power line communication concentrator, and the at least one individual lighting controller may be a power line communication terminal.

The effects of a firmware-remotely-update system and method for the individual lighting controllers in the aviation light system according some embodiments are as follows.

By at least one of embodiments of the present invention, when firmware is updated, a firmware may be directly stored and updated on a program memory equipped in the individual lighting controller without a separate memory for storing thereon the firmware remotely provided.

### BRIEF DESCRIPTION OF DRAWINGS

FIG. 1 is a block diagram illustrating a system for remotely updating firmware of individual lighting controllers in an aviation light system according to an embodiment of the present invention;

FIG. 2 is a block diagram illustrating a firmware-remotely-update method for the individual lighting controllers in the aviation light system according to another embodiment of the present invention; and

FIG. 3 is a block diagram illustrating operations of the individual lighting controllers in a firmware-remotely-update method for the individual lighting controllers in the aviation light system according to still another embodiment of the present invention.

### DETAILED DESCRIPTION

In the following detailed description, embodiments of the present disclosure will be described in detail with reference to the accompanying drawings. Throughout the drawings, like elements will be denoted by the same reference numerals and descriptions thereof will be omitted. As used herein, the term “module” or “unit” is merely intended for easy description of the specification, and the suffix itself does not give any specific meaning or function. Detailed descriptions of well-known functions and structures incorporated herein will be omitted to avoid obscuring the subject matter of the present disclosure. While the present disclosure will be described in detail with reference to the accompanying drawings, it should be understood that the drawings and detailed description thereto are not intended to limit the present disclosure to the particular form disclosed, but on the contrary, the intention is to cover all modifications, equivalents, and alternatives falling within the spirit and scope of the present disclosure as defined by the appended claims.

Furthermore, the terms first, second, and the like therein may be used for describing various elements but the elements are not limited by such terms. The terms are only used for distinguishing between similar elements.

It will have to be understood that when an element is referred to as being “connected” or “coupled” to another element, it can be directly connected or coupled to the other element or intervening elements may be present. In contrast, it will have to be understood that when an element is referred to as being “directly connected” or “directly coupled” to another element, there are no intervening elements present.

The singular form of “a” or “an” includes plural references unless the context clearly dictates otherwise.

It should be understood that the terms “include,” “comprise,” “have” and the like used in the present invention are intended to specify the present of features, numbers, steps, operations, elements, components or combinations thereof described in the disclosure, but do not preclude the presence or addition of one or more other features, numbers, steps, operations, elements, components or combinations thereof.

Hereinafter, embodiments of the present disclosure will be described in detail with reference to the accompanying drawings. It will be apparent to those skilled in the art that the present invention may be embodied in other specific form within a range departing from a spirit and essential features of the present invention.

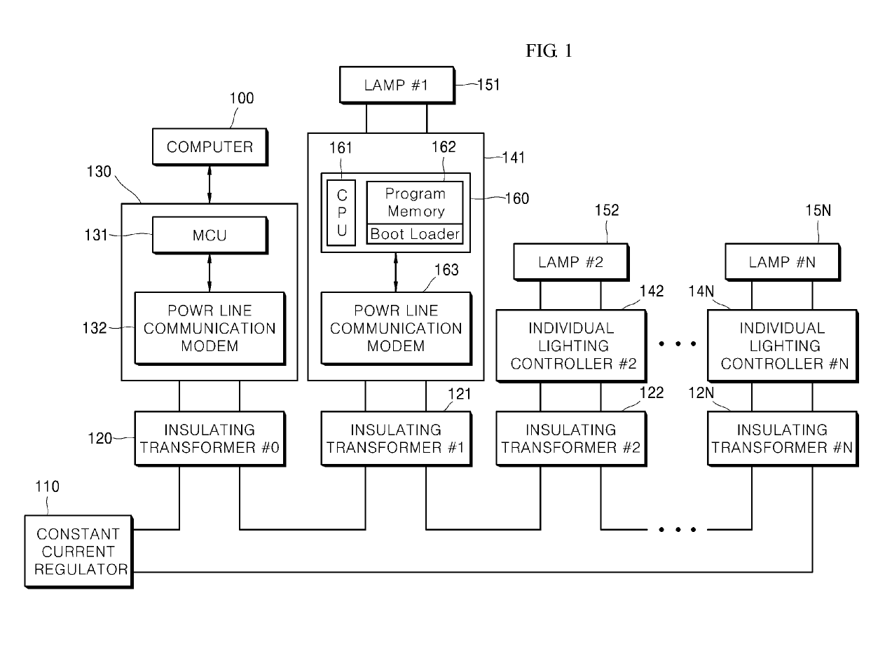

FIG. 1 is a block diagram illustrating a system for remotely updating firmware of individual lighting controllers in an aviation light system according to an embodiment of the present invention.

The configuration view shown in FIG. 1 illustrates a system typically buried beneath airport runway lights. Although the system shown in FIG. 1 is simplified as much as possible for the sake of convenience of description and ease of understanding, an actual implementation thereof may require more complex components and configurations.

The system for remotely updating firmware of the individual lighting controllers in the aviation light system may include a constant current regulator 110, a computer 100, a plurality of insulating transformers 120 to 12N, a relay 130, a plurality of individual lighting controllers 141 to 14N, and a plurality of lamps 151 to 15N.

The constant current regulator 110 together with the plurality of insulating transformers 120 to 12N and a high voltage cable may form a single loop. A constant current provided from the constant current regulator 110 may supply a power to the plurality of lamps 151 to 15N through the single loop.

The relay 130 is for controlling the plurality of individual lighting controllers 141 to 14N forming the single loop together therewith and may be supplied a required power from the constant current regulator 110 by an insulating transformer#0 120.

Each of the plurality of individual lighting controllers 141 to 14N are devices for lighting each of the plurality of lamps 151 to 15N and may be supplied a power required to drive from the plurality of insulating transformers 121 to 12N. Further, each of the plurality of individual lighting controllers 141 to 14N may enable each lamp to be turned on or off, thereby implementing operations required for an air traffic control.

The relay 130 and the plurality of individual lighting controllers 141 to 14N may respectively embed therein modems 132 and 163 for power line communication, and may mutually transmit and receive control instructions using the power line communication. For example, the relay 130 may turn on/off the constant current regulator 110 pursuant to the control instructions transferred from the control tower, and may communicate with the plurality of individual lighting controllers 141 to 14N using the power line communication.

Each of the plurality of individual lighting controllers 141 to 14N may turn on/off one of the plurality of lamps 151 to 15N, coupled to the individual lighting controller itself, or adjust a brightness of the lamp, and may transfer information regarding a state of the lamp to the relay 130. The turn on/off, the brightness adjustment and the like of the plurality of lamps 151 to 15N may be controlled pursuant to the control instructions of the constant current regulator 110 and the relay 130.

The relay 130 may act as a power line communication concentrator and each of the plurality of individual lighting controllers 141 to 14N may act as a power line communication terminal.

A firmware stored in each of the plurality of individual lighting controllers 141 to 14N should be able to be updated pursuant to the mandates applied to the aviation light system and newly developed aviation lights as described above. The individual lighting controllers should be able to be remotely updated due to their nature.

The plurality of individual lighting controllers 141 to 14N may operate in largely two modes. That is, they may operate either as one mode in an application mode of controlling the turn on/off and the brightness adjustment of a lamp (e.g., the lamp 151) or as the other mode in a boot mode of performing the firmware update.

In particular, the plurality of individual lighting controllers 141 to 14N included in the system for remotely updating firmware of the individual lighting controllers in the aviation light system according to the present invention may converse the application mode to the boot mode of performing the firmware update when the firmware should be updated. Further, each of the plurality of individual lighting controllers 141 to 14N may directly store a new firmware transferred from an external device (e.g., the computer) 100 on a program memory 162 equipped therein. The program memory 162 may be preferably a flash program memory but is not limited to a specific memory.

The relay 130 included in the system for remotely updating firmware of the individual lighting controllers in the aviation light system according to the present invention may receive the new firmware and update related data of the new firmware from the external device 100, and may transfer them to the plurality of individual lighting controllers 141 to 14N. In this case, the relay 130 may be connected to the external device 100 by wire or wireless, and may be preferably connected through RS232 or Ethernet to receive the new firmware and the update related data.

The update related data received from the external device 100 by the relay 130 may be various and may include, as one of them, a unique identification (UID) separately specifying each of the plurality of individual lighting controllers. The update related data may also include a memory address identifying which storage location in the program memory 162 an instruction to enter the boot mode or data can be stored on.

Each of the plurality of individual lighting controllers 141 to 14N may determine whether the update related data which an individual lighting controller received contains a UID specifying the individual lighting controller itself, and if so, the individual lighting controller corresponding to the specified UID may perform the firmware update.

Further, each of the plurality of individual lighting controllers 141 to 14N may change its own operational mode from the application mode to the boot mode pursuant to the instruction contained in the update related data which it received. In this case, the change to the boot mode may be performed through a CPU 161 and a boot loader, which are equipped in the individual lighting controller.

In addition, each of the plurality of individual lighting controllers 141 to 14N may identify a memory address contained in the update related data which it received, and then may directly store the firmware received for the update on the storage location in the program memory corresponding to the identified address.

Moreover, depending on a state of the power line communication, a capacity of the new firmware, or the like, the firmware to be newly updated may be divided into multiple pieces of firmware data and transferred from the external device 100 to each of the individual lighting controllers. Herein, the firmware data may be a piece of separate data which is formed by dividing the firmware and all of the multiple pieces of firmware data may be combined, thereby forming a single firmware. In this case, an individual lighting controller being operating in the boot mode may sequentially store the firmware data on one of storage locations, which corresponds to a memory address received along with the firmware data, in the program memory.

Describing a process of storing the firmware received to the individual lighting controllers, each of the plurality of individual lighting controllers 141 to 14N included in the system for remotely updating firmware of the individual lighting controllers in the aviation light system according to the present invention may separate the program memory into an application region or a boot region. That is, the application region in the program memory may be activated when the individual lighting controller is in the application mode of controlling the turn on/off and the brightness adjustment of a relevant lamp, or otherwise the boot region in the program memory may be activated when the individual lighting controller is in the boot mode of performing the update.

Further, when receiving instructions with respect to the firmware update are received through the relay 130 and the external device 100, the individual lighting controller may switch its own program memory to the boot region and then may directly store the received new firmware on the boot region.

Thereafter, when the firmware update is completed, the individual lighting controller may change the boot mode, which the individual lighting controller is operating under, back to the application mode of controlling the turn on/off and the brightness adjustment of the lamp, and accordingly, may switch the program memory back to the application region.

By the configuration above, the system for remotely updating firmware of the individual lighting controllers in the aviation light system according to the present invention may selectively update the firmware in at least one of the plurality of individual lighting controllers 141 to 14N if necessary, and may update the firmware for the individual lighting controller without a separate memory for storing the firmware when the firmware should be updated.

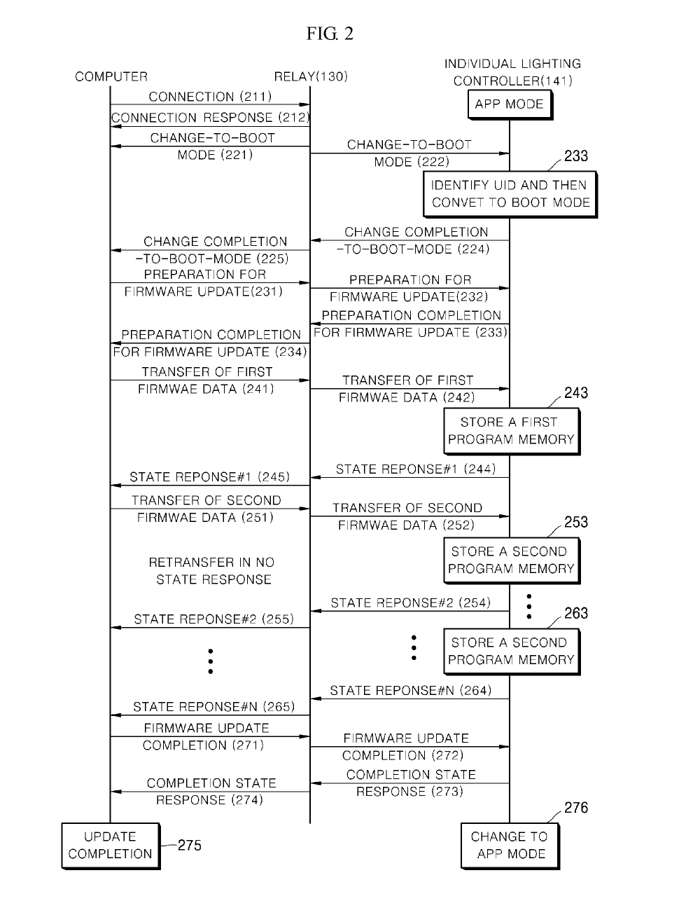

FIG. 2 is a block diagram illustrating a firmware-remotely-update method for the individual lighting controllers in the aviation light system according to another embodiment of the present invention.

First, the computer 100 may transfer a connection request signal to the relay 130 (211). Then, the relay 130 may transfer a signal responding to the connection request signal to the computer 100. Thereby the external device 100 and the relay may be connected by wire or wireless.

Thereafter, the computer 100 may transfer a signal with respect to a change to the boot mode (hereinafter, referred to as an “instruction to enter the boot mode”) to the relay 130 (221). The relay 130 may transfer the instruction to at least one of the plurality of individual lighting controllers (e.g., the individual lighting controller 141) (222). The individual lighting controller (e.g., the individual lighting controller 141) having received the instruction may identify whether a UID having received along with the instruction specifies the individual lighting controller itself, and if so, may change its own operational mode to the boot mode pursuant to the transferred instruction (223).

As described above, the boot mode is a mode of performing the firmware update of the power line communication terminal (i.e., the individual lighting controller) and may include the switching of the program memory equipped in the individual lighting controller from the application region to the boot region. The application region may be a region for the control and operation of each of the plurality of individual lighting controllers and the boot region may be a region for the remote firmware update.

When the change to the boot mode is completed (223), the individual lighting controller 141 may send a signal indicating that the change to the boot mode has been completed to the relay 130 (224) and the relay 130 may send the signal to the external device 100 (225).

Now, the external device 100 may be able to immediately transfer a new firmware (241). However, prior to that, the computer 100, the relay 130, and the individual lighting controller 141 may transmit/receive a signal to/from one another as to whether they prepare and/or are ready to update the firmware whereby they may be set to be states suitable to transfer the new firmware (231 to 234).

Then the external device 100 may transfer the firmware to the relay 130. Specifically, the firmware may be transferred in a form of multiple pieces of firmware data. In this case, a piece of first firmware data may be first transferred to the relay 130 (241). The relay 130 may transfer the received piece of first firmware data to the individual lighting controller 141 (242). The individual lighting controller 141 having received it may identify a memory address, which may be received along with the piece of first firmware data, and then may store the received piece of first firmware data on the program memory (strictly, the boot region) corresponding to the identified memory address (243). The individual lighting controller 141 may send a state response #1 to the relay 130 indicating that the individual lighting controller 141 exactly received the piece of first firmware data and correctly stored it on the program memory (244). The relay 130 may send the received state response #1 to the external device 100 (245).

Thereafter, the external device 100 may transfer a piece of second firmware data (251). Similarly, the relay 130 may transfer it to the individual lighting controller 141 (252), and the individual lighting controller 141 may store it based on a memory address (253) and may send a state response #2 through the relay 130 to the external device 100 (254 and 255).

When the above process is repeated to be completed until a piece of final firmware data is transferred from the external device 100 through the relay 130 to the individual lighting controller 141 and correctly stored (263), the external device 100 may send a signal indicating that the firmware update is completed to the relay 130 (271) and the relay 130 may send it to the individual lighting controller 141 (272). The individual lighting controller 141 having received it may a completion state response through the relay 130 to the external device 100 (273 and 274). The individual lighting controller 141 may change the operational mode, which has been changed to the boot mode in step 223, back to the application mode (276). As the operational mode of the individual lighting controller 141 is changed back to the application mode, the boot region may be also switched back to the application region such that the individual lighting controller 141 can control the turn on/off or the brightness adjustment of the lamp. The external device 100 receiving the completion state response may determine that the firmware update has been completed and then may terminate the operation for the firmware update (275).

By the steps above, the firmware-remotely-update method for the individual lighting controllers in the aviation light system according to the present invention may selectively update the firmware in at least one of the plurality of individual lighting controllers (e.g., the individual lighting controller 141) if necessary, and may update the firmware for the individual lighting controller (e.g., the individual lighting controller 141) without a separate memory for storing the firmware when the firmware should be updated.

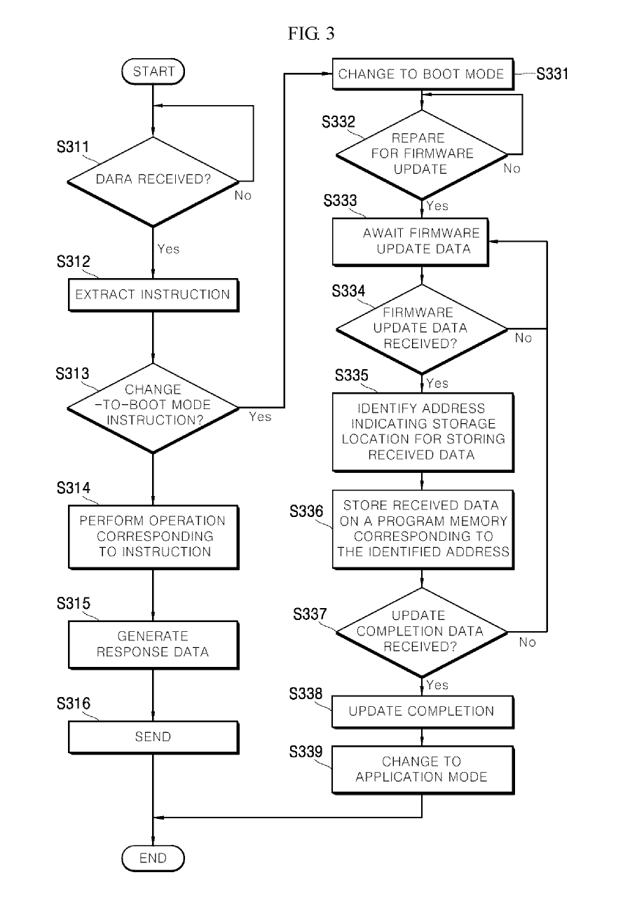

FIG. 3 is a block diagram illustrating a process of specific operations of an individual lighting controller in a firmware-remotely-update method for the individual lighting controllers in the aviation light system according to still another embodiment of the present invention.

In step S311, the individual lighting controller may determine by a power line communication whether data has been received from the relay (or the power line communication concentrator. If it is determined that the data has not been received (No), the process may return to the start, and if otherwise it is determined that the data has been received (Yes), the process may proceed to step S312.

In step S312, the individual lighting controller may extract an instruction contained in the received data. Herein the instruction may be an instruction for controlling the turn on/off or the brightness adjustment of a lamp, or an instruction for the firmware update (e.g., the instruction to enter the boot mode).

In step S313, it is determined whether the instruction extracted in step S312 is for the firmware update. If it is determined that the instruction extracted in step S312 is not for the firmware update (No), an operation corresponding to the instruction may be performed (S314) and a response data relevant to the performed operation may be generated (S315) and sent to the relay (S316).

If otherwise it is determined that the instruction extracted in step S312 is for the firmware update (Yes), the process proceeds step S331 so that the individual lighting controller can change its own operational mode to the boot mode for the firmware update (S331).

In step S332, the individual lighting controller may determine whether it is ready to perform the firmware update. If it is determined that it is ready to perform the firmware update (Yes), in step S333, it may become in a state of awaiting the reception of the new firmware (or the firmware data).

In step S334, it is determined whether the new firmware has been received to the individual lighting controller. If it is determined that the new firmware has not been received to the individual lighting controller (No), the process may return to step S333. If otherwise it is determined that the new firmware has been received to individual lighting controller (Yes), the process may proceed to step S335.

In step S335, the individual lighting controller may identify a memory address indicating a storage location where the received new firmware is to be stored.

In step S336, the individual lighting controller directly stores the new firmware received in step S334 on the storage location of the program memory corresponding to the memory address identified in step S335. The program memory having the new firmware directly stored thereon may be activated to be the boot region under the boot mode which is an operational mode changed in step S331.

In step S337, the individual lighting controller may determine whether data regarding update completion is received. If it is determined that the update completion data has been not received (No), the process may return to step S333 described above to sequentially receive new firmwares. If otherwise it is determined that the update completion data has been received (Yes), the process may proceed to step S338.

The individual lighting controller may complete the firmware update in step S338 and may change its operational mode back to the application mode of controlling the turn on/off or the brightness adjustment of the lamp in step S339. As the operational mode of the individual lighting controller is changed to the application mode, the program memory having activated to be the boot region in step S331 may be switched back to the application region.

As such, the firmware-remotely-update system and method for the individual lighting controllers in the aviation light system may selectively update the firmware for at least one of the plurality of individual lighting controllers if necessary, and may update the firmware of the individual lighting controller without a separate memory for storing the firmware when the firmware should be updated.

The firmware-remotely-update system and method for the individual lighting controllers in the aviation light system according to the embodiments of the present invention described above may be implemented as a computer readable code in a program recording medium. Computer readable recording media include all types of recording devices on which data readable by a computer system may be stored. Examples of computer readable media include HDD (Hard Disk Drive), SSD (Solid State Disk), SDD (Silicon Disk Drive), ROM, RAM, CD-ROM, magnetic tape, floppy disk, optical data storage device, and the like, and may be implemented in a form of carrier waves (e.g., transmission through Internet).

Therefore, the detailed description described above should not be construed as limiting. The scope of the present disclosure should be decided based on the reasonable interpretation of the appended claims and all modifications falling within the equivalent ranges of the disclosure are included in its scope.

What is claimed is:

1. A system for remotely updating firmware of individual lighting controllers in an aviation light system, comprising:
at least one individual lighting controller for, when a firmware is updated with an update, change an application mode for controlling a lamp to a boot mode for performing the update and directly storing the firmware on a program memory equipped therein; and
a relay for receiving the firmware and update related data from an external device to transfer the firmware and the updated related data to the at least one individual lighting controller.

2. The system according to claim 1, wherein the update related data includes a UID (unique identification) separately specifying the at least one individual lighting controller, and
wherein the update is performed for the at least one individual lighting controller based on the UID.

3. The system according to claim 1, wherein the at least one individual lighting controller changes to the boot mode pursuant to an instruction to enter the boot mode in the update related data.

4. The system according to claim 1, wherein the update related data includes a memory address identifying a storage location in the program memory, and
wherein the at least one individual lighting controller directly stores the firmware on the storage location corresponding to the identified memory address.

5. The system according to claim 4, wherein the firmware comprises of multiple pieces of firmware data formed by dividing the firmware,
wherein the at least one individual lighting controller sequentially stores the multiple pieces of firmware data on the storage location corresponding to the identified memory address.

6. The system according to claim 1, wherein the at least one individual lighting controller switches an application region to a boot region in the program memory under the boot mode and directly store the firmware on the boot region,
wherein the application region is a region for a control and an operation of the at least one individual lighting controller, and
wherein the boot region is a region for a remote firmware update.

7. The system according to claim 6, wherein the at least one individual lighting controller changes the boot mode back to the application mode when the update is completed to switch the boot region back to the application region.

8. The system according to claim 1, wherein the at least one individual lighting controller and the relay are connected through a power line communication,
wherein the relay is a power line communication concentrator,
wherein the at least one individual lighting controller is a power line communication terminal.
